(19) United States
(12) Patent Application Publication
(10) Pub. No.: US 2025/0301063 A1
(43) Pub. Date: Sep. 25, 2025

(54) DYNAMIC ADJUSTMENT OF TIMING OF SWITCHING BETWEEN DIFFERENT PAIRING STRATEGIES

(71) Applicant: Afiniti AI Limited, Dublin (IE)

(72) Inventor: Syed Meesum Raza RIZVI, Islamabad (PK)

(73) Assignee: Afiniti AI Limited, Dublin (IE)

(21) Appl. No.: 19/229,491

(22) Filed: Jun. 5, 2025

Related U.S. Application Data
(63) Continuation of application No. PCT/US2023/082838, filed on Dec. 7, 2023.
(60) Provisional application No. 63/431,195, filed on Dec. 8, 2022.

(51) Int. Cl. H04M 3/523

(52) U.S. Cl. CPC H04M 3/5232; H04M 3/5238

(57) ABSTRACT

A method comprising obtaining time data indicating a first time interval. The first time interval is determined based on an expected wait time of contacts for pairing and a first weight value. The method further comprises obtaining pairing data indicating a first plurality of contact-agent pairings performed using a first pairing strategy. A first portion of the first plurality of contact-agent pairings was performed inside the first time interval and a second portion of the first plurality of contact-agent pairings was performed outside the first time interval. The method further comprises determining a number of contact-agent pairings included in the second portion, based on the determined number, modifying the first weight value, thereby generating a second weight value, and determining a second time interval based on the expected wait time and the second weight value. At least one contact-agent pairing included in the second portion is within the second time interval.

### CROSS-REFERENCE TO RELATED APPLICATIONS

This application is a continuation of International Patent Application No. PCT/US2023/082838, filed on 2023 Dec. 7, which claims priority to U.S. provisional patent application No. 63/431,195, filed on 2022 Dec. 8. The above identified applications are incorporated by this reference.

### TECHNICAL FIELD

Disclosed are embodiments related to dynamic adjustment of timing of interchanging different pairing strategies.

### BACKGROUND

There are many scenarios where a task needs to be assigned to an agent. For example, when a customer calls a customer service center of an airline company to request a refund for the customer's airline ticket, an agent of the airline company may need to be assigned to the call to handle the customer's request. In selecting an agent to be paired with the call, a pairing strategy may be used.

Examples of the pairing strategy that can be used for pairing the customer's call with an agent include a “first-in, first-out” (FIFO) strategy, a performance-based routing (PBR) strategy, and a behavioral pairing (BP) strategy. The fundamental principles of FIFO strategy, PBR strategy, and BP strategy are known in the field, and thus detailed explanation about the strategies is not provided in this disclosure. Note that there are various types of the BP strategy, and information about the different types of the BP strategy are provided, for example, in U.S. Pat. Nos. 9,300,802, 9,781,269, 9,787,841, 9,930,180, and 10,757,262 all of which are hereby incorporated by reference herein.

Using an appropriate pairing strategy for pairing tasks (e.g., customers' calls) with agents is important not only for efficient usage of agents and contact center computing resources but also for customer satisfaction. For example, in a scenario where customers #1 and #2 are waiting to talk to agents, and agents #1 and #2 are currently available, if customer #1 contacted the customer center before customer #2 contacted the customer center, and if agent #1 became available before agent #2 became available, under FIFO strategy, customer #1 will be paired with agent #1, and customer #2 will be paired with agent #2. However, if the purpose of customer #1's call is to ask questions about purchasing a particular product and agent #2 (but not agent #1) is a sales specialist for the particular product, it is better to pair customer #1 with agent #2 instead of agent #1. Thus, in this scenario, FIFO was not the optimal strategy to use for the pairing.

As explained above, using an appropriate pairing strategy for pairing tasks with agents is important not only for efficient usage of agents and contact center resources but also for customer satisfaction, and there are service provider(s) providing to those companies of the agents (e.g., the airline company) improved pairing strategies for pairing agents with tasks. Note that, in this disclosure, those companies (e.g., the airline company in the example provided above) to which pairing strategies are provided by the service providers are referred as enterprise clients.

There are different types of pairing strategies. For example, a first type of pairing strategy (e.g., such as FIFO strategy) is configured to pair a task with an agent as soon as the task and the agent become available, and such first pairing strategy may be preconfigured at and/or a default pairing strategy of the enterprise client. On the contrary, a second type of pairing strategy (e.g., such as BP strategy) may be configured to wait until more tasks and/or more agents become available, expecting that better suited agents for the currently available tasks (than the currently available agents) would become available later, and/or the second type of pairing strategy may be configured to pair tasks and agents in out-of-sequence orderings. In some examples where the service provider's pairing strategy is of the second type (e.g., BP strategy) and an enterprise client decides to use the service provider's pairing strategy, the enterprise client may decide to use the service provider's pairing strategy in conjunction with its preconfigured pairing strategy. The rationale for using multiple pairing strategies may be that enterprise clients do not generally want their customers to wait too long before the customers are paired with agents, thinking that longer wait times would negatively affect customer satisfaction. Each task is generally associated with a maximum wait time for the service provider's pairing strategy to pair the task to an agent, before a pairing module requires the task to be paired with the enterprise client's preconfigured or default pairing strategy instead of the service provider's pairing strategy.

The length of the maximum wait time may be set by the service provider and/or the enterprise client. In this disclosure, the length of the maximum wait time is also referred to as a service level agreement (SLA) period. The SLA period between a service provider A and an enterprise client B may indicate the maximum wait time within which the service provider A's pairing strategy (a.k.a., pairing algorithm) should pair a contact with an agent. After the maximum wait time, a preconfigured pairing strategy (i.e., the pairing strategy different from the service provider A's pairing strategy) will be used by the enterprise client B for pairing. The amount of service fees the enterprise client B pays the service provider A may depend on a percentage of the number of pairs created by the service provider A's pairing strategy within the SLA period. Thus, for this reason and other reasons set forth below, it is very important for the service provider A to set the SLA period correctly.

### SUMMARY

Certain challenges presently exist. For example, in the existing art, the SLA period (a.k.a., the maximum wait time) is too static for contact center environments. For example, before Christmas and New Year holidays, there may be, at a customer service center of a clothing store, sudden increased volume of calls from customers, requesting to purchase gifts. In such situations, many calls will not be paired with agents within the SLA period regardless of the type of pairing strategies that is used for the pairing (e.g., regardless of whether a preconfigured pairing strategy is used for the pairing or a service provider pairing strategy is used for the pairing).

However, as discussed above, the amount of service fees the enterprise client pays to the service provider may depend on a percentage and/or volume of the number of pairs created under the service provider's pairing strategy within the SLA period; accordingly, having too many calls that are not paired with agents within the SLA period is disadvantageous to the service provider. Therefore, there is a need to dynamically adjust the SLA period depending on the contact center environment.

Accordingly, in one aspect of the embodiments of this disclosure, there is provided a method. The method comprises obtaining time data indicating a first time interval, wherein the first time interval is determined based on an expected wait time of contacts for pairing and a first weight value. The method further comprises obtaining pairing data indicating a first plurality of contact-agent pairings performed using a first pairing strategy, wherein a first portion of the first plurality of contact-agent pairings was performed inside the first time interval and a second portion of the first plurality of contact-agent pairings was performed outside the first time interval. The method further comprises determining a number of contact-agent pairings included in the second portion, and, based on the determined number, modifying the first weight value, thereby generating a second weight value. The method further comprises determining a second time interval based on the expected wait time and the second weight value, wherein at least one contact-agent pairing included in the second portion is within the second time interval.

In another aspect of the embodiments of this disclosure, there is provided a method. The method comprises obtaining time data indicating a first time interval, wherein the first time interval is determined based on an expected wait time of contacts for pairing, a first weight value, and a first buffer value. The method further comprises obtaining pairing data indicating a first plurality of contact-agent pairings performed using a first pairing strategy, wherein a first portion of the first plurality of contact-agent pairings was performed inside the first time interval and a second portion of the first plurality of contact-agent pairings was performed outside the first time interval. The method further comprises determining a number of contact-agent pairings included in the second portion, and based on the determined number of contact-agent pairings included in the second portion, modifying the first buffer value, thereby generating a second buffer value. The method further comprises determining a second time interval based on the expected wait time, the first weight value, and the second buffer value, wherein at least one contact-agent pairing included in the second portion of the first plurality of contact-agent pairings is within the second time interval.

In another aspect of the embodiments of this disclosure, there is provided a computer program comprising instructions which when executed by processing circuitry of a node causes the node to perform the method of any one of the above embodiments.

In another aspect of the embodiments of this disclosure, there is provided a carrier containing the computer program of the above embodiment, wherein the carrier is one of an electronic signal, an optical signal, a radio signal, and a computer readable storage medium.

In another aspect of the embodiments of this disclosure, there is provided a node. The node comprises processing circuitry and being configured to perform the method of any one of the embodiments described above.

The accompanying drawings, which are incorporated herein and form part of the specification, illustrate various embodiments.

### BRIEF DESCRIPTION OF THE DRAWINGS

FIG. 1A shows a system according to some embodiments.

FIG. 1B shows a pairing strategy switching scheme according to some embodiments.

FIG. 1C shows an example communication system according to some embodiments.

FIG. 1D shows an example communication system according to some embodiments.

FIG. 1E shows an example communication system according to some embodiments.

FIG. 2 shows processes according to some embodiments.

FIGS. 3A and 3B show methods of adjusting an SLA period according to some embodiments.

FIG. 4 shows a process according to some embodiments.

FIG. 5 shows a process according to some embodiments.

FIG. 6 shows an apparatus according to some embodiments.

### DETAILED DESCRIPTION

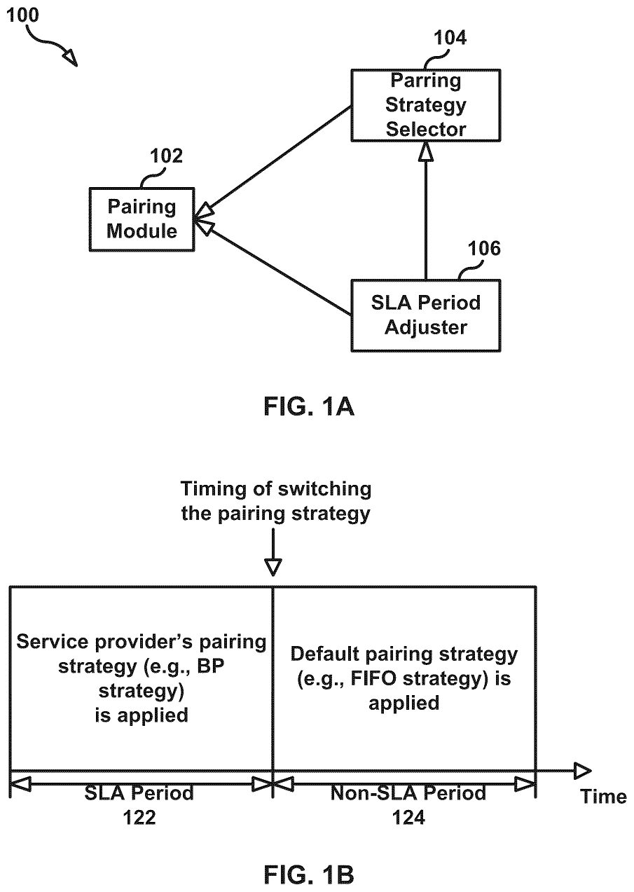

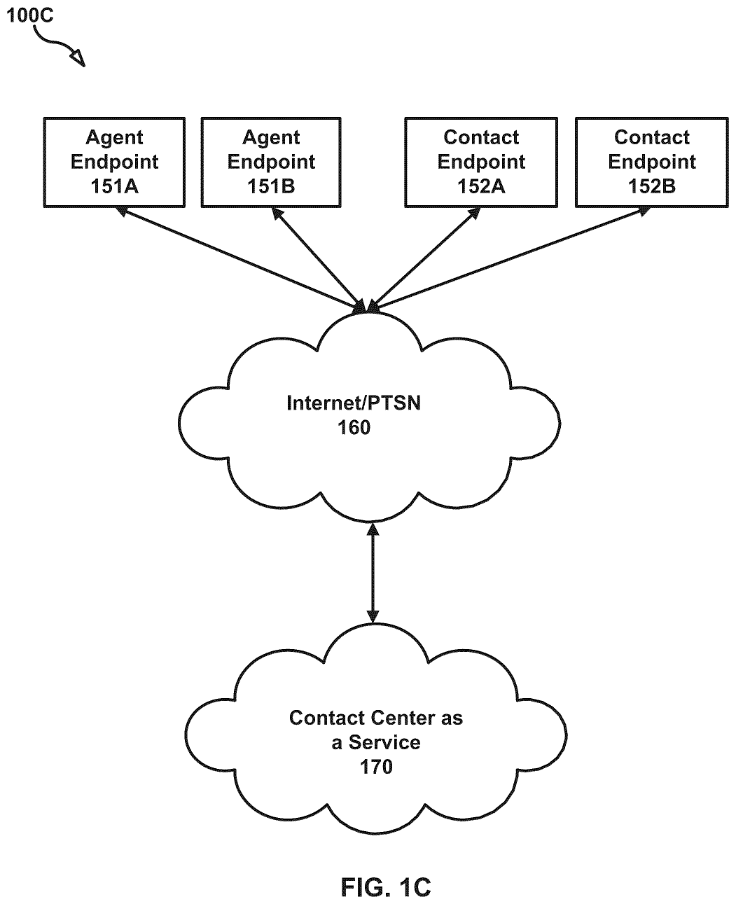

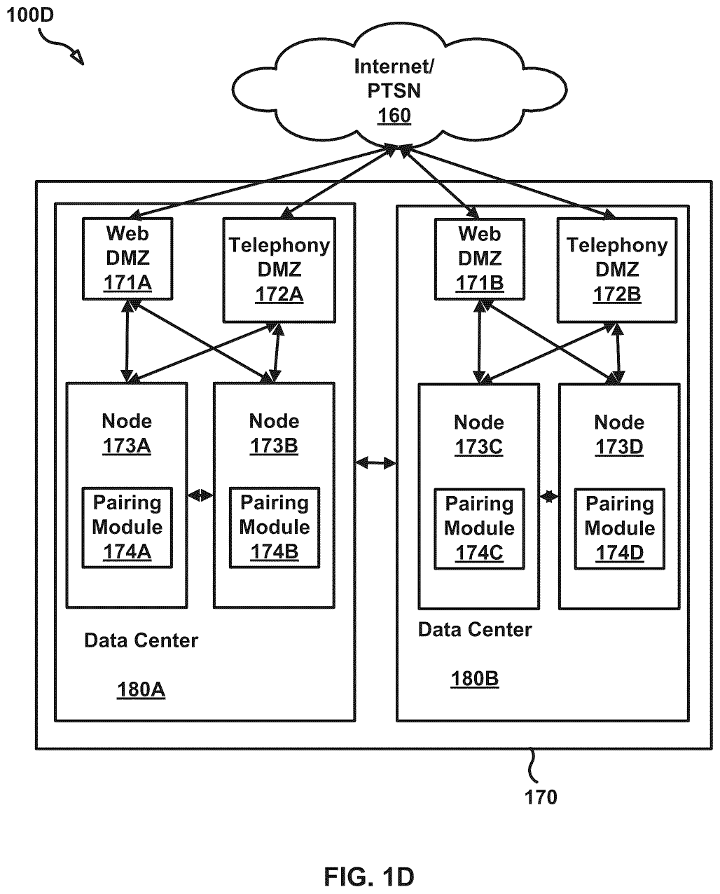

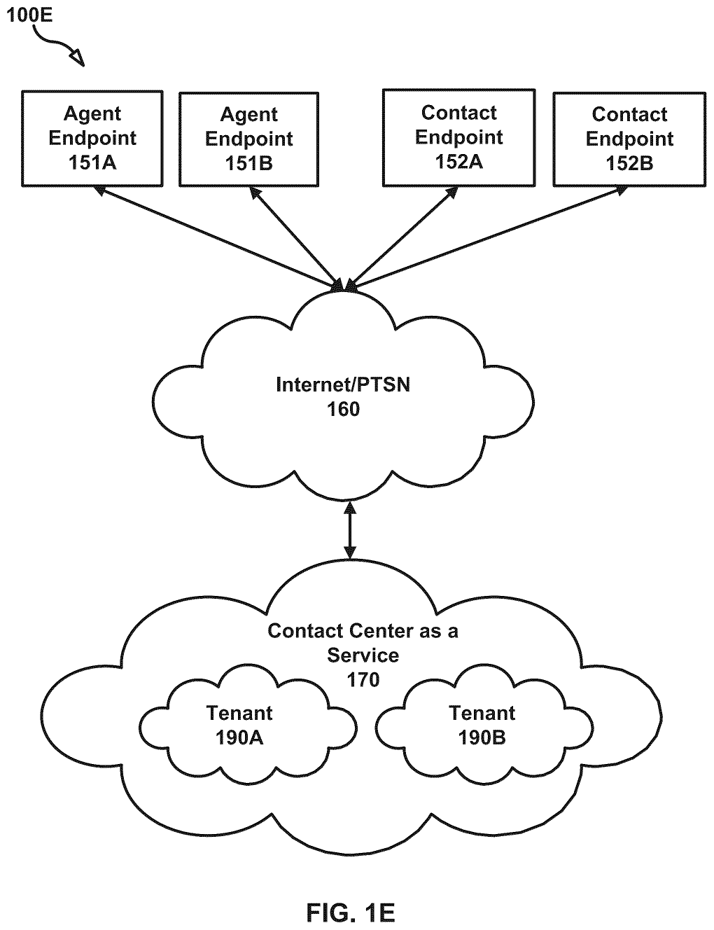

FIG. 1A shows a system 100 according to some embodiments. System 100 comprises a pairing module 102, a pairing strategy selector 104, and an SLA period adjuster 106. Even though FIG. 1A shows that pairing module 102, pairing strategy selector 104, and SLA period adjuster 106 are three separate entities, in some embodiments, two or more of the three separate entities may be included in a single entity.

Pairing module 102 is configured to pair one or more tasks (e.g., calls from customers of an airline company) with agents (e.g., agents of the airline company). The pairing of the tasks with the agents may be performed using a pairing strategy selected by pairing strategy selector 104. For example, pairing strategy selector may select BP strategy and transmit to pairing module 102 an indication indicating that BP strategy is to be used for pairing. For example, each task may have a strategy identifier flag associated with the task, wherein a value of the flag is associated with a particular pairing strategy (e.g., a value of ‘0’ indicates that the service provider pairing strategy is to be used, and a value of ‘1’ indicates that a default pairing strategy is to be used). SLA period adjuster 106 is configured to adjust the SLA period length and indicate to pairing module 102 and/or pairing strategy selector 104 such that the adjusted SLA period length can be used for subsequent pairings. For example, a value of the strategy identifier flag of each task may be determined based on a current SLA period length and a wait time of the task. Detailed explanation of how SLA period adjuster 106 adjusts the SLA period is provided below.

As explained above, in some cases, system 100 may use a pairing strategy provided by a service provider for pairing its customers with its agents. In those cases, since the enterprise client does not want its customers to wait too long before the customers are paired with agent, the system 100 may initially associate the service provider's pairing strategy (which may not result in the fastest pairing) with a task for within a certain interval of time (i.e., the SLA period), and then associate a different pairing strategy (which generally results in the fastest pairing) with the task for any time period after the certain interval.

FIG. 1C illustrates an example communication system 100A. In this example, communication system 100A is a contact center system. As shown in FIG. 1C, the communication system 100A may include a central switch 110. The central switch 110 may receive incoming contacts (e.g., callers) or support outbound connections to contacts via a telecommunications network (not shown). The central switch 110 may include contact routing hardware and software for helping to route contacts among one or more contact centers, or to one or more Private Branch Exchanges (PBXs) and/or Automatic Call Distributers (ACDs) or other queuing or switching components, including other Internet-based, cloud-based, or otherwise networked contact-agent hardware or software-based contact center solutions.

The central switch 110 may not be necessary such as if there is only one contact center, or if there is only one PBX/ACD routing component, in the communication system 100A. If more than one contact center is part of the communication system 100A, each contact center may include at least one contact center switch (e.g., contact center switches 120A and 120B). The contact center switches 120A and 120B may be communicatively coupled to the central switch 110. In embodiments, various topologies of routing and network components may be configured to implement the contact center system.

Each contact center switch for each contact center may be communicatively coupled to a plurality (or “pool”) of agents. Each contact center switch may support a certain number of agents (or “seats”) to be logged in at one time. At any given time, a logged-in agent may be available and waiting to be connected to a contact, or the logged-in agent may be unavailable for any of a number of reasons, such as being connected to another contact, performing certain post-call functions such as logging information about the call, or taking a break.

In the example of FIG. 1C, the central switch 110 routes contacts to one of two contact centers via contact center switch 120A and contact center switch 120B, respectively. Each of the contact center switches 120A and 120B are shown with two agents each. Agents 130A and 130B may be logged into contact center switch 120A, and agents 130C and 130D may be logged into contact center switch 120B.

The communication system 100A may also be communicatively coupled to an integrated service from, for example, a third party vendor. In the example of FIG. 1C, a pairing node 140 may be communicatively coupled to one or more switches in the switch system of the communication system 100A, such as central switch 110, contact center switch 120A, or contact center switch 120B. In some embodiments, switches of the communication system 100A may be communicatively coupled to multiple pairing nodes. In some embodiments, pairing node 140 may be embedded within a component of a contact center system (e.g., embedded in or otherwise integrated with a switch). The pairing node 140 may receive information from a switch (e.g., contact center switch 120A) about agents logged into the switch (e.g., agents 130A and 130B) and about incoming contacts via another switch (e.g., central switch 110) or, in some embodiments, from a network (e.g., the Internet or a telecommunications network) (not shown).

A contact center may include multiple pairing nodes. In some embodiments, one or more pairing nodes may be components of pairing node 140 or one or more switches such as central switch 110 or contact center switches 120A and 120B. In some embodiments, a pairing node may determine which pairing node may handle pairing for a particular contact. For example, the pairing node may alternate between enabling pairing via a Behavioral Pairing (BP) strategy and enabling pairing with a First-in-First-out (FIFO) strategy. In other embodiments, one pairing node (e.g., the BP pairing node) may be configured to emulate other pairing strategies.

FIG. 1D illustrates a second example communication system 100B. As shown in FIG. 1D, the communication system 100B may include one or more agent endpoints 151A, 151B and one or more contact endpoints 152A, 152B. The agent endpoints 151A, 151B may include an agent terminal and/or an agent computing device (e.g., laptop, cellphone). The contact endpoints 151A, 151B may include a contact terminal and/or a contact computing device (e.g., laptop, cellphone). Agent endpoints 151A, 151B and/or contact endpoints 152A, 152B may connect to a Contact Center as a Service (CCaaS) 170 through either the Internet or a public switched telephone network (PSTN), according to the capabilities of the endpoint device.

FIG. 1E illustrates an example communication system 100C with an example configuration of a CCaaS 170. For example, a CCaaS 170 may include multiple data centers 180A, 180B. The data centers 180A, 180B may be separated physically, even in different countries and/or continents. The data centers 180A, 180B may communicate with each other. For example, one data center is a backup for the other data center; so that, in some embodiments, only one data center 180A or 180B receives agent endpoints 151A, 151B and contact endpoints 152A, 152B at a time.

Each data center 180A, 180B includes web demilitarized zone equipment 171A and 171B, respectively, which is configured to receive the agent endpoints 151A, 151B and contact endpoints 152A, 152B, which are communicatively connecting to CCaaS via the Internet. Web demilitarized zone (DMZ) equipment 171A and 171B may operate outside a firewall to connect with the agent endpoints 151A, 151B and contact endpoints 152A, 152B while the rest of the components of data centers 180A, 180B may be within said firewall (besides the telephony DMZ equipment 172A, 172B, which may also be outside said firewall). Similarly, each data center 180A, 180B includes telephony DMZ equipment 172A and 172B, respectively, which is configured to receive agent endpoints 151A, 151B and contact endpoints 152A, 152B, which are communicatively connecting to CCaaS via the PSTN. Telephony DMZ equipment 172A and 172B may operate outside a firewall to connect with the agent endpoints 151A, 151B and contact endpoints 152A, 152B while the rest of the components of data centers 180A, 180B (excluding web DMZ equipment 171A, 171B) may be within said firewall.

Further, each data center 180A, 180B may include one or more nodes 173A, 173B, and 173C, 173D, respectively. All nodes 173A, 173B and 173C, 173D may communicate with web DMZ equipment 171A and 171B, respectively, and with telephony DMZ equipment 172A and 172B, respectively. In some embodiments, only one node in each data center 180A, 180B may be communicating with web DMZ equipment 171A, 171B and with telephony DMZ equipment 172A, 172B at a time.

Each node 173A, 173B, 173C, 173D may have one or more pairing modules 174A, 174B, 174C, 174D, respectively. Similar to pairing module 140 of communications system 100A of FIG. 1C, pairing modules 174A, 174B, 174C, 174D may pair contacts to agents. For example, the pairing module may alternate between enabling pairing via a Behavioral Pairing (BP) module and enabling pairing with a First-in-First-out (FIFO) module. In other embodiments, one pairing module (e.g., the BP module) may be configured to emulate other pairing strategies.

Turning now to FIG. 1E, the disclosed CCaaS communication systems (e.g., FIGS. 1B and/or 1C) may support multi-tenancy such that multiple contact centers (or contact center operations or businesses) may be operated on a shared environment. That is, each tenant may have a separate, non-overlapping pool of agents. CCaaS 170 is shown in FIG. 1E as comprising two tenants 190A and 190B. Turning back to FIG. 1D, for example, multi-tenancy may be supported by node 173A supporting tenant 190A while node 173B supports 190B. In another embodiment, data center 180A supports tenant 190A while data center 180B supports tenant 190B. In another example, multi-tenancy may be supported through a shared machine or shared virtual machine; such at node 173A may support both tenants 190A and 190B, and similarly for nodes 173B, 173C, and 173D.

In other embodiments, the system may be configured for a single tenant within a dedicated environment such as a private machine or private virtual machine.

FIG. 1B illustrates how system 100 may associate different pairing strategies at different times for pairing a task with an agent. In FIG. 1B, during a first period 122, the service provider's pairing strategy (e.g., BP strategy) would be used to pair the task, but during a second period 124 (which is after first period 122), a different pairing strategy (herein after, this pairing strategy is referred as a “default pairing strategy”) would be used to pair a task.

For example, the length of the first period 122 may be determined by a current length of an SLA period. There are different types of SLA periods: Agent_SLA period and Contact_SLA period. The Agent_SLA period indicates how long an agent can wait for pairing with a task under the service provider's pairing strategy before the default pairing strategy must be used for the pairing. The Contact_SLA period indicates how long a customer (a contact) can wait for pairing with an agent under the service provider's pairing strategy before the default pairing strategy must be used for the pairing.

In one example, Agent_SLA period (a.k.a., “Agent_SLA”) and Contact_SLA period (a.k.a., “Contact_SLA”) may be expressed as the following functions:

$$Agent\_SLA = Multiplier * Average\_Agent \_Wait \_Time ( AAWT ) + Buffer ; and$$

$$Contact\_SLA = Multiplier * Estimated\_Waiting \_Time ( EWT ) + Buffer$$

Agent_Wait_Time indicates how long an agent waited before being paired with a task. In one example, Agent_Wait_Time=Agent_Connect_Time_for_Call_N−Agent_Free_Time_from_Call_N−1 (e.g., if the agent becomes free from call N−1 at time 9:05.00, and the agent is connected to call N at time 9:05.50, then the Agent_Wait_Time is 50 seconds).

Average_Agent_Wait_Time is the average of the Agent_Wait_Times for a set of agents (e.g., the Average_Agent_Wait_Time between 9:00 and 10:00 is the average of the Agent_Wait_Times for a set of agents at the contact center during 9:00 and 10:00).

Estimated_Waiting_Time (EWT) indicates how long a contact is estimated to wait for pairing with an agent. For example,

$$EWT = ( CR * \frac{AverageHandleTime}{AvailableAgents} ) * WaitingCalls ; and$$

$$CR = \frac{TotalAbandonedCalls}{TotalCalls}$$

Multiplier in the Agent_SLA and Contact_SLA functions is any positive real number that can be used for weighting the Average_Agent_Wait_Time and/or the Estimated_Waiting_Time. For example, the Multiplier may be 1.2 for both the Contact_SLA and the Agent_SLA (Note that the Multiplier for Agent_SLA may be same as or different from the Multiplier for Contact_SLA). In some embodiments, the Multiplier may vary according to a priority level (e.g., of calls) such that higher priority levels are associated with lower Multipliers and lower priority levels are associated with higher Multipliers. The logic behind this relationship between the Multiplier and the priority level is that the more important a call is, the shorter a waiting time should be.

Buffer is another factor that contributes to the SLAs. In one example, the Buffer for the Contact_SLA may be equal to 30 seconds and the Buffer for the Agent_SLA may be equal to 100 seconds. Like the Multipliers, the Buffer may vary according to a priority level (e.g., of calls) such that the higher the priority level is, the lower the Buffer value should be and the lower the priority level is, the higher the Buffer value should be. The logic behind this relationship is same as the logic behind the relationship between the Multiplier and the priority level.

When a default pairing strategy (e.g., a FIFO strategy) is used for pairing tasks (for example, during second period 124), the standard deviation of agent/contact wait time may be very low because agents and contacts are paired in sequence. On the contrary, when a service provider's pairing strategy (e.g., a BP strategy) is used for pairing tasks (for example, during first period 122), the standard deviation may be much higher because the service provider's pairing strategy would pair contacts and agents out of order. As an example, contact #1 and contact #2 were both paired by a default pairing strategy, and contact #1 had 10 seconds of actual wait time and contact #2 had 400 seconds of actual wait time, resulting in an average wait time of 205 seconds. By contrast, contact #3 and contact #4 were both paired by a service provider's pairing strategy, and contact #3 had 200 seconds of actual wait time and contact #4 had 210 seconds of actual wait time, resulting in an average wait time of 205 seconds.

Even though the average wait time may be the same for any task, regardless of whether the task is associated with the default pairing strategy or the service provider's pairing strategy, the service provider's pairing strategy (despite the fact that the wait time for contact #2 was long) may provide greater performance than the default pairing strategy. For example, a first performance measurement of the outcomes of contact #1 and contact #2 after pairing by the service provider's pairing strategy may be higher than a second performance measurement of the outcomes of contact #3 and contact #4 after pairing by the default pairing strategy. Therefore, in the SLA functions provided above, the Buffer value is provided to adjust the SLA period (i.e., the maximum wait time) to allow for the longer standard deviations of agent/contact pairings when the service provider's pairing strategy is in use.

Unfortunately, the above Agent_SLA and Contact_SLA formulas are too static for contact center environments, especially in time periods where there is a sudden influx of activity at the contact center (e.g., promotional periods, holidays). For example, if the default pairing strategy (i.e., the pairing strategy that is not the service provider's pairing strategy) pairs more than a threshold amount of contact-agent pairings after the SLA period, then there may be an EWT/AAWT calculation problem. The problem can be due to many reasons, including the following. For example, perhaps (1) the AverageHandleTime increases suddenly, (2) there is not enough evidence to calculate EWT/AAWT correctly for a particular skill or queue, (3) there is a complex client environment due to priorities, overflow calls or other reasons, or (4) there may be other fluctuations in the contact center environment.

Tables 1-3 provided below illustrate the problem of using the static SLA formulas—i.e., the problem of too many tasks (e.g., contacts) being paired with agents after the SLA period. Table 1 shows the status of contacts waiting in a queue at time to when the SLA period is equal to 200 s.

TABLE 1

| Contact | Wait Time (Seconds) | Flag |
|---|---|---|
| C1 | 150 | 0 |
| C2 | 125 | 0 |
| C3 | 98 | 0 |
| C4 | 72 | 0 |
| C5 | 4 | 0 |

In Tables 1-3, the “Wait Time” indicates a time duration during which a particular contact has been waiting to be paired, and the “Flag” indicates a particular pairing strategy should be used for pairing a particular contact (e.g., 0 corresponds to a first pairing strategy and 1 corresponds to a second pairing strategy).

In Table 1, the “Wait Time” of all of contacts C1-C5 is less than 200 s (i.e., the SLA period). Thus, all of the contacts are assigned to a first pairing strategy (e.g., the service provider's pairing strategy). Table 2 shows the status of contacts waiting in the pairing queue at time t=t1 (e.g., 100 s later than t0), and the SLA period remains equal to 200 s.

TABLE 2

| Contact | Wait Time (Seconds) | Flag |
|---|---|---|
| C1 | 250 | 1 |
| C2 | 225 | 1 |
| C3 | 198 | 0 |
| C5 | 104 | 0 |
| C6 | 63 | 0 |
| C7 | 24 | 0 |

During the time interval between t0 and t1, C4 is paired, and C6 and C7 are newly added to the pairing queue. Thus, in Table 2, the queue does not include C4 but includes C6 and C7. Because 100 s has passed, the Wait Time of remaining contacts C1, C2, C3, and C5 has increased by 100 s in Table 2; therefore, the “Wait Time” of C1 and C2 is more than the SLA period (i.e., 200 seconds), and thus the second pairing strategy (corresponding to the “Flag” value of 1) is now associated with C1 and C2, and must be used for pairing C1 and C2. Because the “Wait Time” of C3, C5, C6, and C7 is less than the SLA period, the first pairing strategy (corresponding to the “Flag” value of 0) is associated with each of C3, C5, C6, and C7.

Table 3 shows the status of contacts waiting in the pairing queue at time t=t2 (e.g., 200 s after t0) when the SLA period is equal to 200 s.

TABLE 3

| Contact | Wait Time (Seconds) | Flag |
|---|---|---|
| C2 | 325 | 1 |
| C3 | 298 | 1 |
| C5 | 204 | 1 |
| C6 | 163 | 0 |
| C7 | 124 | 0 |
| C8 | 16 | 0 |

During the time interval between t1 and t2, C1 is paired by the default pairing strategy, and C8 is newly added to the pairing queue. Thus, in Table 3, the queue does not include C1 but includes C8. Also, in Table 3, the “Wait Time” of C3 and C5 is more than the SLA period (i.e., 200 seconds), and thus the second pairing strategy (corresponding to the “Flag” value of 1) is now newly associated with C3 and C5, and must be used for pairing C3 and C5. Thus, C2, C3, and C5 are now each associated with the second pairing strategy. On the contrary, because the “Wait Time” of C6, C7, and C8 is less than the SLA period, the first pairing strategy (corresponding to the “Flag” value of 0) is associated with C6, C7, and C8.

As shown above, if too many tasks (e.g., calls) are paired with agents after the SLA period, it may be unfairly disadvantageous to the service provider providing a pairing strategy. For example, as explained above with respect to FIG. 1B, in using the service provider's pairing strategy, the service provider's pairing strategy may only be used during the SLA period and then the default pairing strategy must be used after the SLA period. In this scenario, the amount of service fees the enterprise client pays to the service provider may depend on a volume of pairs generated by the service provider's pairing strategy and/or a percentage of the number of pairs generated by the service provider's pairing strategy within the SLA period.

Thus, if tasks (e.g., a call) are paired with agents after the SLA period by the default pairing strategy, the service provider may not collect any service fee from the pairings, and the contact center may not be technically optimized according to the superior technical resource allocation that would be performed by the service provider's pairing strategy over the default pairing strategy. However, such restriction is unfair when even the default pairing strategy is unable to pair the tasks with agents before the SLA period expires. For example, as shown in Tables 1-3 provided above, even after the pairing strategy used for pairing contact C2 is switched from the first pairing strategy (corresponding to the “Flag” value of 0) to the second pairing strategy (corresponding to the “Flag” value of 1), contact C2 still has not been paired. Therefore, such delay in the pairings for tasks originally associated with the service provider's pairing strategy is not actually caused by a performance of the service provider's pairing strategy. Rather, the delay in the pairings is caused by sudden increase in the number of tasks (e.g., calls) to be handled or other fluctuations in the contact center environment, as otherwise discussed herein.

Further, if the above Agent_SLA and Contact_SLA formulas are too static to compensate for the complexity of a contact center environment, a conventional contact center system will spend valuable system resources, such as bandwidth, processing power, and memory, to interchange the service provider's pairing strategy with the default pairing strategy, when such interchanging does not result in faster contact center pairings. The consumption of systems resources is particularly concerning when the contact center is operating in a high-capacity manner due to a high volume and influx of system requests (e.g., many callers on hold, etc.).

Therefore, there is a need to efficiently adjust the SLA period(s) in a dynamic manner depending on the condition of a contact center environment.

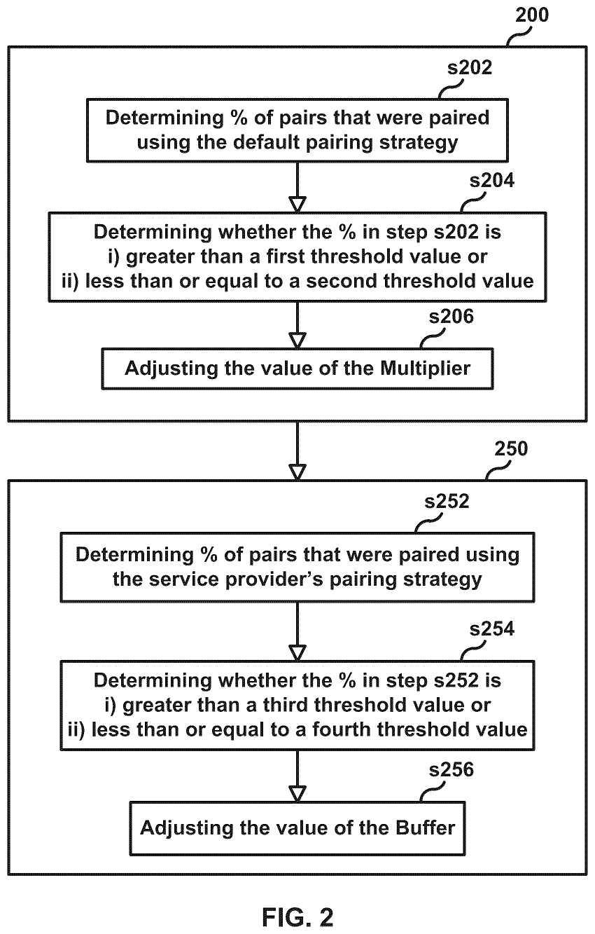

Accordingly, in some embodiments, SLA settings (i.e., the parameters of the above SLA functions such as Multiplier and Buffer) may be dynamically adjusted based on a current contact center environment. The method of dynamically adjusting the SLA settings comprises two processes 200 and 250 shown in FIG. 2.

Process 200—Treating Situation where Default Pairing Strategy does not Complete Enough Pairings within the SLA Period

Process 200 may begin with step s202. Step s202 comprises determining a percentage of task-agent pair(s) that were paired using the default pairing strategy (i.e., the pairing strategy that is different from the service provider's pairing strategy) after the expiration of the SLA period (e.g., the Contact_SLA). That is, step s202 may also comprise determining a first SLA period (e.g., an initial Contact_SLA). As discussed above, the Contact_SLA may be defined as: Contact_SLA=Multiplier*Estimated_Waiting_Time+Buffer. In one example, the value of Multiplier is equal to 1.2, and the value of the Buffer is equal to 30 (meaning that an initial Contact_SLA=1.2*EWT+30).

Then process 200 may proceed to step s204. Step s204 comprises determining whether the percentage determined in step s202 is i) greater than a first threshold percentage or ii) less than or equal to a second threshold percentage. For example, the first threshold percentage is 0.5%, 1%, 2%, 3%, 5%, or 10%, and the second threshold percentage is close to 0%, 0.5%, or 1%. In case any of the conditions (i) and (ii) is satisfied, there is an OFF SLA problem.

If more than the first threshold percentage of the pairings occur after the expiration of the SLA period, the EWT/AAWT is not being calculated properly. In such case, process 200 may proceed to step s206. Step s206 comprises adjusting the value of the Multiplier. More specifically, in this scenario, step s206 comprises increasing the value of the Multiplier to make the SLA period closer to the actual current contact center environment.

If less than or equal to the second threshold percentage of pairings do not occur after the expiration of the SLA period, then it may mean that the EWT/AAWT is not being calculated properly. In such case, it may be desirable to provide a failsafe to make sure that the SLA period is not incorrectly too generous. Thus, process 200 may proceed to step s206. Step s206 adjusting the value of the Multiplier. More specifically, in this scenario, step s206 comprises decreasing the value of the Multiplier by a set value.

Process 200—Exemplary Scenario #1—the Percentage is Greater than a First Threshold Percentage

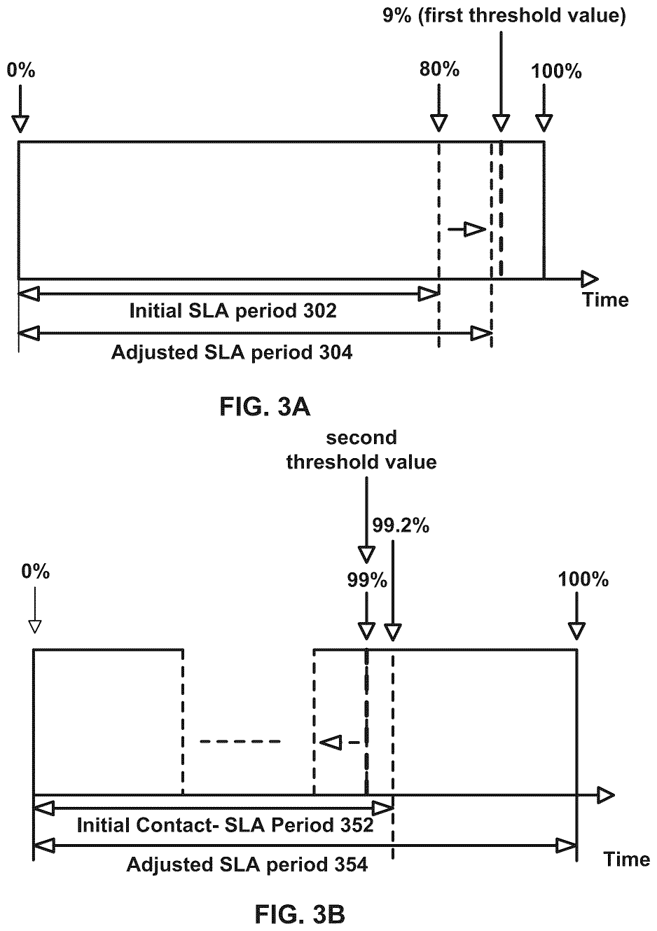

FIG. 3A shows a scenario where 20% of calls that were paired with agents using the default pairing strategy (e.g., the FIFO strategy) were paired after an initial SLA period 302 (obtained by a Contact_SLA formula) shown in FIG. 3A was expired. In this scenario, the percentage determined in step s202 would be 20%.

In case the first threshold percentage is 9%, in step s204, it would be determined that the percentage determined in step s202 is greater than the first threshold percentage. Then, process 200 would proceed to step s206a. Step s206a comprises adjusting the initial Contact_SLA formula based on the percentage determined in step s212, by increasing the value of the Multiplier. In some embodiments, the initial Contact_SLA formula is (Multiplierᵢₙᵢₜᵢₐₗ)×EWT+Buffer. The initial Contact_SLA formula may be adjusted as follows: Contact_SLA′=(Multiplierᵢₙᵢₜᵢₐₗ+Multiplier_{modifier})*EWT+Buffer.

Here, Multiplierᵢₙᵢₜᵢₐₗ is equal to the Multiplier value in the initial Contact_SLA formula and the Contact_SLA′ corresponds an adjusted Contact_SLA period 304 shown in FIG. 3A. Multiplier_{modifier} may be determined based on the percentage determined in step s202. For example, Multiplier_{modifier} may be equal to the determined percentage/100 (a.k.a., ratio). Thus, in the above example, the ratio may be 20/100=0.2 ratio.

Since, in the above example, the value of Multiplierᵢₙᵢₜᵢₐₗ is equal to 1.2 and the Buffer value is equal to 30, the adjusted Contact_SLA formula may be expressed as:

$$Contact\_SLA ’ = ( 1.2 + 0.2 ) \times EWT + 30.$$

In some scenarios, even after adjusting the Contact_SLA formula, the percentage determined in step s202 may still be higher than the first threshold percentage. For example, as shown in FIG. 3A, even after the Contact_SLA period is updated from the initial time period 302 to the adjusted time period 304, there may be a scenario where ˜10% of the calls paired using the default PS are still paired after the adjusted Contact_SLA period 304 is expired.

Thus, according to some embodiments, steps s202-s206 may be repeated (meaning the Contact_SLA′ formula may be repeatedly updated) until the percentage determined in step s202 is no longer greater than the first threshold percentage. In other words, as illustrated in FIG. 3A, the Contact_SLA period may be continuously extended (i.e., continuously moved to the right) such that less percentage of the calls paired using the default pairing strategy is outside the Contact_SLA period.

Process 200—Exemplary Scenario #2—the Percentage is Less than or Equal to a Second Threshold Percentage

FIG. 3B shows a scenario where 0.8% (or in another example, 0%) of calls that were paired using the default pairing strategy (e.g., the FIFO strategy) were paired after an initial Contact_SLA period 352 shown in FIG. 3B was expired. In this scenario, the percentage determined in step s202 would be 0.8%.

In case the second threshold percentage is 1%, in step s204, it would be determined that the percentage determined in step s202 is less than the second threshold percentage. Then, process 200 would proceed to step s216. Step s216 comprises adjusting the initial Contact_SLA formula based on the percentage determined in step s202, by decreasing the value of the Multiplier by a set value. As discussed above, the initial Contact_SLA formula may be expressed as follows: Contact_SLA=Multiplier*Estimated_Waiting_Time+Buffer.

There are various ways of decreasing the value of the Multiplier. In one example, the Multiplier value may be adjusted by decreasing the Multiplier value by a predetermined percentage (e.g., 10%).

In another example, the Multiplier value may be adjusted by multiplying Multiplierᵢₙᵢₜᵢₐₗ by the percentage of pairings that did occur before the expiration of the SLA time period (that is 0.992). More specifically, in such example, the adjusted Contact_SLA formula may be expressed as follows: Contact_SLA′=Contact_SLA=(Multiplierᵢₙᵢₜᵢₐₗ*Multiplier_{Reduction})×EWT+Buffer. Here, Multiplier_{Reduction} is 0.992.

In another example, the Multiplier value may be adjusted by subtracting a value that is determined based on the percentage determined in step s202. More specifically, in such example, the adjusted Contact_SLA formula may be expressed as follows: Contact_SLA′=Contact_SLA=(Multiplierᵢₙᵢₜᵢₐₗ−Multiplier_{Reduction})×EWT+Buffer. Here, Contact_SLA′ corresponds an adjusted Contact_SLA period 354 shown in FIG. 3B, Multiplierᵢₙᵢₜᵢₐₗ is equal to the Multiplier value in the initial Contact_SLA formula, and Multiplier_{Reduction} may be equal to Multiplierᵢₙᵢₜᵢₐₗ*PredeterminedAmount. Thus, in case the initial Contact_SLA period formula is 1.4*EWT+30, and the PredeterminedAmount value is equal to 0.1, the adjusted Contact_SLA period formula would be (1.4−(1.4*0.1))*EWT+30=1.26*EWT+30. Like the exemplary scenario #1 above, steps s202-s206 may be repeated (meaning the Contact_SLA formula may be repeatedly updated) until the percentage determined in step s202 is no longer less than or equal to the second threshold percentage. In other words, as illustrated in FIG. 3B, the Contact_SLA period may be continuously shrunk (i.e., may be continuously moved to the left) such that more percentage of the calls paired using the default pairing strategy is outside the Contact_SLA period. In a summary, these techniques attempt to keep the contact center in an environment where the percentage of pairings that were made using the default pairing strategies after the SLA time period expired hovers between the first threshold percentage and the second threshold percentage.

Process 204—Treating Situation where Service Provider's Pairing Strategy does not Complete Enough Pairings within the SLA Period

If more than the first threshold percentage of pairings of the service provider's pairing strategy were paired after the expiration of the SLA period (while less than the first threshold percentage of pairings of the default pairing strategy were paired after the expiration of the SLA period), the EWT and/or AAWT is probably being calculated properly. However, the Buffer value of the SLA formula may need to be adjusted to consider the operation of the service provider's pairing strategy which may perform the pairings out of sequence.

Thus, according to some embodiments, after performing process 200 via which the Multiplier value is adjusted, process 250 may be performed to adjust the Buffer value. Process 250 may begin with step s252. Assume that the adjusted SLA period (e.g., adjusted Contact_SLA)=1.2*EWT+30, step s252 comprises determining a percentage of contacts/agents that were paired using the service provider's pairing strategy after the adjusted Contact_SLA period was expired. After determining the percentage, process 250 may proceed to step s254.

Step s254 comprises determining whether the percentage is i) greater than a third threshold percentage or ii) less than or equal to a fourth threshold percentage. For example, the third threshold percentage is 1%, 2%, 3%, 4% or 5% and the fourth threshold percentage is close to 0%. For example, if close to 0% of pairings do not occur after the expiration of the SLA period, then the Buffer value should be decreased as a failsafe to ensure that the SLA is not incorrectly too generous. In such case, process 250 may proceed to step s256. Step s256 comprises decreasing the Buffer value by a set value.

Exemplary Scenario #1 for Process 250—the Percentage is Greater than a Third Threshold Percentage

Consider a scenario where 20% of calls paired using the service provider's pairing strategies are paired after the Contact_SLA (e.g., the Contact_SLA obtained from process 202) has expired. Here, the percentage determined in step s252 would be 20%. In step s254, a determination is made as to whether the percentage is greater than the third threshold percentage. In case the third threshold percentage is 3%, in step s254, it would be determined that the percentage is greater than the third threshold percentage, and process 250 may proceed to step s256. Because the percentage determined in step s252 is greater than the third threshold percentage, in step s256, the Contact_SLA formula may be adjusted by adjusting the Buffer value based on the determined percentage.

For example, the adjusted Contact SLA formula may be determined as follows: Contact_SLA=Multiplier*EWT+Bufferᵢₙᵢₜᵢₐₗ+Buffer_{Modifier}. For example, Buffer_{Modifier} may be a set value such as 1, 5, 10, 15, 20, 25, 30, etc. Buffer_{Modifier} may be a predetermined percentage (1%, 2%, 3%, 5%, 10%, 15%, 20%, 25%, 50%, etc.) of Bufferᵢₙᵢₜᵢₐₗ. In some examples, Buffer_{Modifier} may have a variable value, based on a length of time since the Contact_SLA function was last adjusted. In some examples, Buffer_{Modifier} may have a variable value, based on a number of times that the Contact_SLA function was adjusted during a set period of time. In some embodiments, Buffer_{Modifier}=Ratio*100 where Ratio is equal to the percentage determined in step s252 divided by 100. Thus, in case the percentage is 20%, the Ratio would be 0.2. Then the Buffer_{Modifier} would be 20 seconds. Since the Contact_SLA is 1.2*EWT+30, the adjusted Contact_SLA is would be 1.2*EWT+50.

In some embodiments, steps 252-256 may be repeated (meaning the Contact_SLA may be continuously adjusted) until the percentage is no longer greater than the third threshold percentage.

Exemplary Scenario #2 for Process 250—the Percentage is Less than or Equal to a Fourth Threshold Percentage

Consider a scenario where 0.8% (or, in another example, 0%) of calls paired using the service provider's pairing strategy are paired after the Contact_SLA (e.g., the Contact_SLA obtained from process 202) has expired. Here, the percentage determined in step s252 would be 0.8%. In step s254, a determination is made as to whether the percentage is less than or equal to the fourth threshold percentage. In case the percentage is less than or equal to the fourth threshold percentage, process 250 may proceed to step s256. In step s256, the Contact SLA formula may be adjusted. The new Contact_SLA is always determined based on the previous Contact_SLA. Thus, in case the previous SLA was: Contact_SLA=1.2*EWT+30, the updated SLA would be Contact_SLA′=Multiplier*EWT+Bufferᵢₙᵢₜᵢₐₗ−Buffer_{Reduction}.

Note that this reduction—and, that is, a value of Buffer_{Reduction}—may be performed in various ways. For example, Buffer_{Reduction} can be a predetermined amount (e.g., 5, 10, 15, 20, 30 seconds) or Buffer_{Reduction} may be a predetermined percentage (1%, 2%, 3%, 5%, 10%, 15%, 20%, 25%, 50%, etc.) of Bufferᵢₙᵢₜᵢₐₗ. In some examples, Buffer_{Reduction} may have a variable value, based on a length of time since the Contact_SLA function was last adjusted. In some examples, Buffer_{Reduction} may have a variable value, based on a number of times that the Contact_SLA function was adjusted during a set period of time. In some embodiments, Buffer_{Reduction}=Ratio*100 where Ratio is equal to the percentage determined in step s256 divided by 100. Thus, in case the percentage is 0.8%, the Ratio would be 0.008. Then the Buffer_{Reduction} would be 0.8 seconds.

Like the exemplary scenario #1 above, steps s252-s256 may be repeated (meaning the Contact_SLA formula may be repeatedly updated) until the percentage determined in step s202 is no longer less than or equal to the fourth threshold percentage. In a summary, these techniques attempt to keep the contact center in an environment where the percentage of pairings that were made using the service provider's pairing strategies after the SLA time period expired hovers between the third threshold percentage and the fourth threshold percentage.

Referring back to the examples illustrated in Tables 1-3 provided above, by adjusting the SLA period, more tasks (e.g., contacts) can be paired using the service provider's pairing strategy such that the performance of the service provider's pairing strategy can be fairly evaluated.

Table 4 shows the status of contacts waiting in the pairing queue at time t=t2 (e.g., 200 s after t0) when the SLA period is updated to 300 s according to embodiments of the present disclosure (as compared to Table 3 provided above, where the SLA period is set to 200 s and did not change from the initial SLA period length).

TABLE 4

| Contact | Wait Time (Seconds) | Flag |
|---|---|---|
| C3 | 298 | 0 |
| C5 | 204 | 0 |
| C6 | 163 | 0 |
| C7 | 124 | 0 |
| C8 | 16 | 0 |

Contrary to Table 3, in Table 4, the “Wait Time” of C3 and C5 is less the SLA period (i.e., 300 seconds), and thus the first pairing strategy (corresponding to the “Flag” value of 0) may be used for all contacts C3, C5, C6, C7, and C8 in the pairing queue.

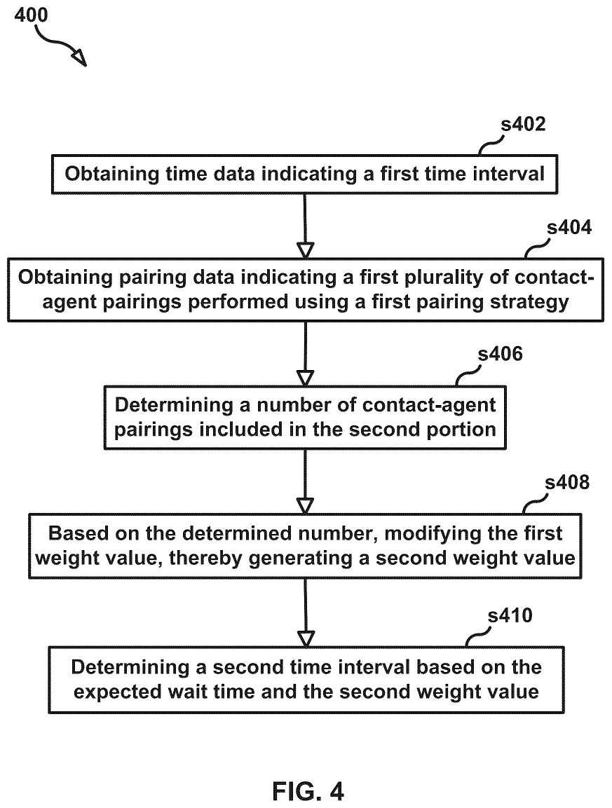

FIG. 4 shows a process 400 according to some embodiments. Process 400 may begin with step s402. Step s402 comprises obtaining time data indicating a first time interval, wherein the first time interval is determined based on an expected wait time of contacts for pairing and a first weight value. Step s404 comprises obtaining pairing data indicating a first plurality of contact-agent pairings performed using a first pairing strategy, wherein a first portion of the first plurality of contact-agent pairings was performed inside the first time interval and a second portion of the first plurality of contact-agent pairings was performed outside the first time interval. Step s406 comprises determining a number of contact-agent pairings included in the second portion. Step s408 comprises, based on the determined number, modifying the first weight value, thereby generating a second weight value. Step s410 comprises determining a second time interval based on the expected wait time and the second weight value, wherein at least one contact-agent pairing included in the second portion is within the second time interval.

In some embodiments, process 400 comprises determining a first ratio of the determined number of contact-agent pairings included in the second portion and a total number of the first plurality of contact-agent pairings, comparing the first ratio to a first threshold value and/or a second threshold value, thereby determining whether the first ratio is greater than the first threshold value or is less than or equal to the second threshold value, wherein the first weight value is modified in case the first ratio is greater than the first threshold value or is less than or equal to the second threshold value, and the second threshold value is less than the first threshold value.

In some embodiments, the first ratio is greater than the first threshold value, and modifying the first weight value comprises increasing the first weight value.

In some embodiments, the second time interval is calculated based on (the first weight value+a modification weight value)*the expected wait time, and the modification weight value is determined based on the first ratio.

In some embodiments, the modification weight value is equal to the first ratio.

In some embodiments, the first ratio is less than or equal to the second threshold value, and modifying the first weight value comprises decreasing the first weight value.

In some embodiments, the second time interval is calculated based on (the first weight value−a modification weight value)*the expected wait time, and the modification weight value is determined based on the first ratio.

In some embodiments, the modification weight value is equal to the first weight value×a1, where a1 is a ratio of a number of contact-agent pairings included in the first portion and the total number of the first plurality of contact-agent pairings.

In some embodiments, process 400 comprises obtaining updated pairing data indicating a second plurality of contact-agent pairings performed using the first pairing strategy, wherein a first portion of the second plurality of contact-agent pairings was performed inside the second time interval and a second portion of the second plurality of contact-agent pairings was performed outside the second time interval; determining a number of contact-agent pairings included in the second portion of the second plurality of contact-agent pairings; based on the determined number of contact-agent pairings included in the second portion of the second plurality of contact-agent pairings, modifying the second weight value, thereby generating a third weight value; and determining a third time interval based on the expected wait time and the third weight value, wherein at least one contact-agent pairing included in the second portion of the second plurality of contact-agent pairings is within the third time interval.

In some embodiments, process 400 comprises obtaining updated pairing data indicating a second plurality of contact-agent pairings performed using a second pairing strategy, wherein a first portion of the second plurality of contact-agent pairings was performed inside the second time interval and a second portion of the second plurality of contact-agent pairings was performed outside the second time interval; determining a number of contact-agent pairings included in the second portion of the second plurality of contact-agent pairings; based on the determined number of contact-agent pairings included in the second portion of the second plurality of contact-agent pairings, modifying a first buffer value, thereby generating a second buffer value; and determining a third time interval based on the expected wait time, the second weight value, and the second buffer value, wherein the second time interval is determined based on the expected wait time, the second weight value, and the first buffer value, and at least one contact-agent pairing included in the second portion of the second plurality of contact-agent pairings is within the third time interval.

In some embodiments, process 400 comprises determining a second ratio of the determined number of contact-agent pairings included in the second portion of the second plurality of contact-agent pairings and a total number of the second plurality of contact-agent pairings; comparing the second ratio to a first threshold value and/or a second threshold value, thereby determining whether the second ratio is greater than the first threshold value or is less than or equal to the second threshold value, wherein the first buffer value is modified in case the second ratio is greater than the first threshold value or is less than or equal to the second threshold value, and the second threshold value is less than the first threshold value.

In some embodiments, the second ratio is greater than the first threshold value, and modifying the first buffer value comprises increasing the first buffer value.

In some embodiments, the third time interval is calculated based on (the second weight value×the expected wait time)+the first buffer value+a modification buffer value, and the modification buffer value is determined based on the second ratio.

In some embodiments, the modification buffer value is equal to the second ratio×100.

In some embodiments, the second ratio is less than or equal to the second threshold value, and modifying the first buffer value comprises decreasing the first buffer value.

In some embodiments, the third time interval is calculated based on (the second weight value×the expected wait time)+the first buffer value−a modification buffer value, and the modification buffer value is determined based on the second ratio.

In some embodiments, the modification buffer value is equal to the first buffer value×a1, where a1 is a ratio of a number of contact-agent pairings included in the first portion of the second plurality of contact-agent pairings and the total number of the second plurality of contact-agent pairings.

In some embodiments, process 400 comprises obtaining updated pairing data indicating a third plurality of contact-agent pairings performed using the second pairing strategy, wherein a first portion of the third plurality of contact-agent pairings was performed inside the third time interval and a second portion of the third plurality of contact-agent pairings was performed outside the third time interval; determining a number of contact-agent pairings included in the second portion of the third plurality of contact-agent pairings; based on the determined number of contact-agent pairings included in the second portion of the third plurality of contact-agent pairings, modifying the second buffer value, thereby generating a third buffer value; and determining a fourth time interval based on the expected wait time and the third buffer value, wherein at least one contact-agent pairing included in the second portion of the third plurality of contact-agent pairings is within the fourth time interval.

In some embodiments, process 400 comprises performing contact-agent pairings using the first pairing strategy within the third time interval, and performing contact-agent pairings using the second pairing strategy outside the third time interval.

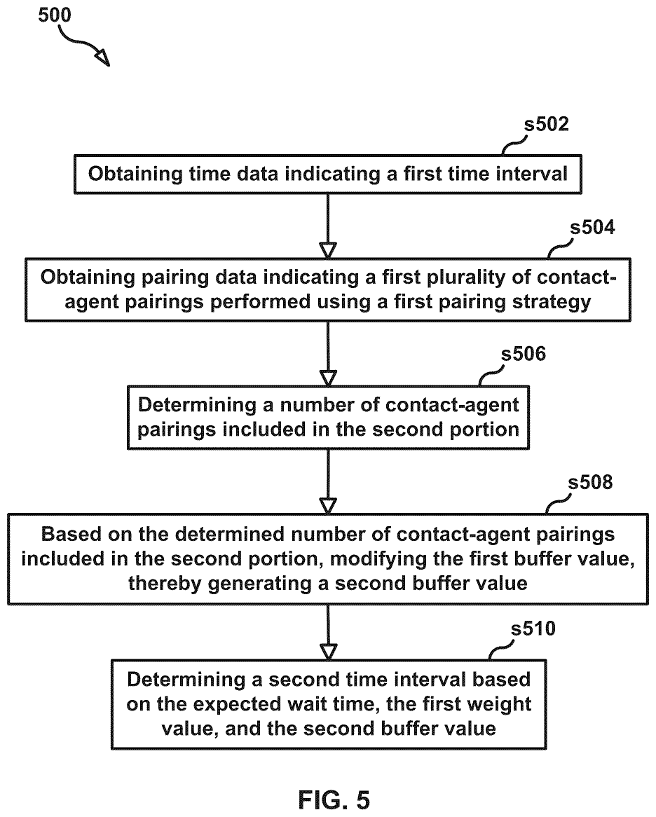

FIG. 5 shows a process 500 according to some embodiments. Process 500 may begin with step s502. Step s502 comprises obtaining time data indicating a first time interval, wherein the first time interval is determined based on an expected wait time of contacts for pairing, a first weight value, and a first buffer value. Step s504 comprises obtaining pairing data indicating a first plurality of contact-agent pairings performed using a first pairing strategy, wherein a first portion of the first plurality of contact-agent pairings was performed inside the first time interval and a second portion of the first plurality of contact-agent pairings was performed outside the first time interval. Step s506 comprises determining a number of contact-agent pairings included in the second portion. Step s508 comprises, based on the determined number of contact-agent pairings included in the second portion, modifying the first buffer value, thereby generating a second buffer value. Step s510 comprises determining a second time interval based on the expected wait time, the first weight value, and the second buffer value, wherein at least one contact-agent pairing included in the second portion of the first plurality of contact-agent pairings is within the second time interval.

In some embodiments, process 500 comprises determining a first ratio of the determined number of contact-agent pairings included in the second portion of the first plurality of contact-agent pairings and a total number of the first plurality of contact-agent pairings; comparing the first ratio to a first threshold value and/or a second threshold value, thereby determining whether the first ratio is greater than the first threshold value or is less than or equal to the second threshold value, wherein the first buffer value is modified in case the first ratio is greater than the first threshold value or is less than or equal to the second threshold value, and the second threshold value is less than the first threshold value.

In some embodiments, the first ratio is greater than the first threshold value, and modifying the first buffer value comprises increasing the first buffer value.

In some embodiments, the second time interval is calculated based on (the first weight value×the expected wait time)+the first buffer value+a modification buffer value, and the modification buffer value is determined based on the first ratio.

In some embodiments, the modification buffer value is equal to the first ratio×100.

In some embodiments, the first ratio is less than or equal to the second threshold value, and modifying the first buffer value comprises decreasing the first buffer value.

In some embodiments, the second time interval is calculated based on (the first weight value×the expected wait time)+the first buffer value−a modification buffer value, and the modification buffer value is determined based on the first ratio.

In some embodiments, the modification buffer value is equal to the first buffer value×a1, where a1 is a ratio of a number of contact-agent pairings included in the first portion of the first plurality of contact-agent pairings and the total number of the first plurality of contact-agent pairings.

In some embodiments, process 500 comprises obtaining updated pairing data indicating a second plurality of contact-agent pairings performed using the first pairing strategy, wherein a first portion of the second plurality of contact-agent pairings was performed inside the second time interval and a second portion of the second plurality of contact-agent pairings was performed outside the second time interval; determining a number of contact-agent pairings included in the second portion of the second plurality of contact-agent pairings; based on the determined number of contact-agent pairings included in the second portion of the second plurality of contact-agent pairings, modifying the second buffer value, thereby generating a third buffer value; and determining a third time interval based on the expected wait time, the first weight value, and the third buffer value, wherein at least one contact-agent pairing included in the second portion of the second plurality of contact-agent pairings is within the third time interval.

In some embodiments, process 500 comprises performing contact-agent pairings using the first pairing strategy outside the second time interval, and performing contact-agent pairings using a second pairing strategy within the second time interval.

In some embodiments, process 500 comprises obtaining updated pairing data indicating a second plurality of contact-agent pairings performed using a second pairing strategy, wherein a first portion of the second plurality of contact-agent pairings was performed inside the second time interval and a second portion of the second plurality of contact-agent pairings was performed outside the second time interval; determining a number of contact-agent pairings included in the second portion of the second plurality of contact-agent pairings; based on the determined number of contact-agent pairings included in the second portion of the second plurality of contact-agent pairings, modifying the first weight value, thereby generating a second weight value; and determining a third time interval based on the expected wait time, the second weight value, and the second buffer value, wherein at least one contact-agent pairing included in the second portion of the second plurality of contact-agent pairings is within the third time interval.

In some embodiments, process 500 comprises determining a second ratio of the determined number of contact-agent pairings included in the second portion of the second plurality of contact-agent pairings and a total number of the second plurality of contact-agent pairings; comparing the second ratio to a first threshold value and/or a second threshold value, thereby determining whether the second ratio is greater than the first threshold value or is less than or equal to the second threshold value, wherein the first weight value is modified in case the second ratio is greater than the first threshold value or is less than or equal to the second threshold value, and the second threshold value is less than the first threshold value.

In some embodiments, the second ratio is greater than the first threshold value, and modifying the first weight value comprises increasing the first weight value.

In some embodiments, the third time interval is calculated based on (the first weight value+a modification weight value)*the expected wait time+the second buffer value, and the modification weight value is determined based on the second ratio.

In some embodiments, the modification weight value is equal to the second ratio.

In some embodiments, the second ratio is less than or equal to the second threshold value, and modifying the first weight value comprises decreasing the first weight value.

In some embodiments, the third time interval is calculated based on (the first weight value−a modification weight value)*the expected wait time+the second buffer value, and the modification weight value is determined based on the second ratio.

In some embodiments, the modification weight value is equal to the first weight value×a1, where a1 is a ratio of a number of contact-agent pairings included in the first portion of the second plurality of contact-agent pairings and the total number of the second plurality of contact-agent pairings.

In some embodiments, process 500 comprises obtaining updated pairing data indicating a third plurality of contact-agent pairings performed using the second pairing strategy, wherein a first portion of the third plurality of contact-agent pairings was performed inside the third time interval and a second portion of the second plurality of contact-agent pairings was performed outside the third time interval; determining a number of contact-agent pairings included in the second portion of the third plurality of contact-agent pairings; based on the determined number of contact-agent pairings included in the second portion of the third plurality of contact-agent pairings, modifying the second weight value, thereby generating a third weight value; and determining a fourth time interval based on the expected wait time, the second buffer value, and the third weight value, wherein at least one contact-agent pairing included in the second portion of the third plurality of contact-agent pairings is within the fourth time interval.

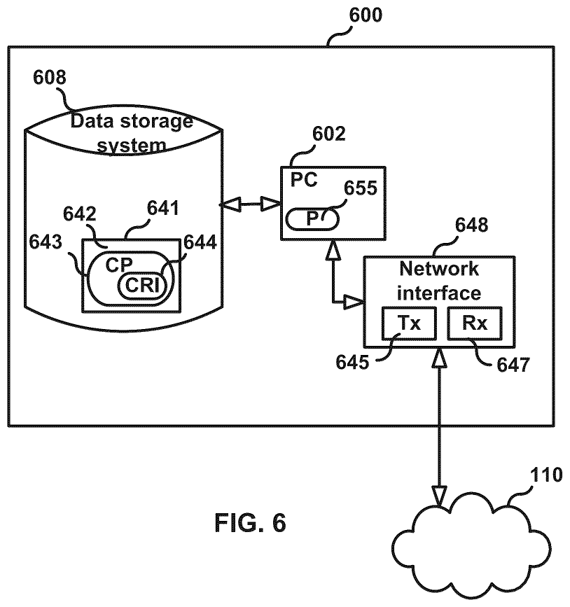

FIG. 6 is a block diagram of an apparatus 600, according to some embodiments, for implementing any one or more of pairing module 102, pairing strategy selector 104, and/or SLA period adjuster 106. As shown in FIG. 6, apparatus 600 may comprise: processing circuitry (PC) 602, which may include one or more processors (P) 655 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., apparatus 600 may be a distributed computing apparatus); a network interface 648 comprising a transmitter (Tx) 645 and a receiver (Rx) 647 for enabling apparatus 600 to transmit data to and receive data from other nodes connected to a network 110 (e.g., an Internet Protocol (IP) network) to which network interface 648 is connected (directly or indirectly) (e.g., network interface 648 may be wirelessly connected to the network 110, in which case network interface 648 is connected to an antenna arrangement); and a local storage unit (a.k.a., “data storage system”) 608, which may include one or more non-volatile storage devices and/or one or more volatile storage devices. In embodiments where PC 602 includes a programmable processor, a computer program product (CPP) 641 may be provided. CPP 641 includes a computer readable medium (CRM) 642 storing a computer program (CP) 643 comprising computer readable instructions (CRI) 644. CRM 642 may be a non-transitory computer readable medium, such as, magnetic media (e.g., a hard disk), optical media, memory devices (e.g., random access memory, flash memory), and the like. In some embodiments, the CRI 644 of computer program 643 is configured such that when executed by PC 602, the CRI causes apparatus 600 to perform steps described herein (e.g., steps described herein with reference to the flow charts). In other embodiments, apparatus 600 may be configured to perform steps described herein without the need for code. That is, for example, PC 602 may consist merely of one or more ASICs. Hence, the features of the embodiments described herein may be implemented in hardware and/or software.

### Summary of Embodiments

A1. A method (400) comprising: obtaining (s402) time data indicating a first time interval, wherein the first time interval is determined based on an expected wait time of contacts for pairing and a first weight value; obtaining (s404) pairing data indicating a first plurality of contact-agent pairings performed using a first pairing strategy, wherein a first portion of the first plurality of contact-agent pairings was performed inside the first time interval and a second portion of the first plurality of contact-agent pairings was performed outside the first time interval; determining (s406) a number of contact-agent pairings included in the second portion; based on the determined number, modifying (s408) the first weight value, thereby generating a second weight value; and determining (s410) a second time interval based on the expected wait time and the second weight value, wherein at least one contact-agent pairing included in the second portion is within the second time interval.

A2. The method of embodiment A1, comprising: determining a first ratio of the determined number of contact-agent pairings included in the second portion and a total number of the first plurality of contact-agent pairings; comparing the first ratio to a first threshold value and/or a second threshold value, thereby determining whether the first ratio is greater than the first threshold value or is less than or equal to the second threshold value, wherein the first weight value is modified in case the first ratio is greater than the first threshold value or is less than or equal to the second threshold value, and the second threshold value is less than the first threshold value.

A3. The method of embodiment A2, wherein the first ratio is greater than the first threshold value, and modifying the first weight value comprises increasing the first weight value.

A4. The method of embodiment A2 or A3, wherein the second time interval is calculated based on (the first weight value+a modification weight value)*the expected wait time, and the modification weight value is determined based on the first ratio.

A5. The method of embodiment A4, wherein the modification weight value is equal to the first ratio.

A6. The method of embodiment A2, wherein the first ratio is less than or equal to the second threshold value, and modifying the first weight value comprises decreasing the first weight value.

A7. The method of embodiment A2 or A6, wherein the second time interval is calculated based on (the first weight value−a modification weight value)*the expected wait time, and the modification weight value is determined based on the first ratio.

A8. The method of embodiment A7, wherein the modification weight value is equal to the first weight value×a1, where a1 is a ratio of a number of contact-agent pairings included in the first portion and the total number of the first plurality of contact-agent pairings. A9. The method of any one of embodiments A1-A8, comprising: obtaining updated pairing data indicating a second plurality of contact-agent pairings performed using the first pairing strategy, wherein a first portion of the second plurality of contact-agent pairings was performed inside the second time interval and a second portion of the second plurality of contact-agent pairings was performed outside the second time interval; determining a number of contact-agent pairings included in the second portion of the second plurality of contact-agent pairings; based on the determined number of contact-agent pairings included in the second portion of the second plurality of contact-agent pairings, modifying the second weight value, thereby generating a third weight value; and determining a third time interval based on the expected wait time and the third weight value, wherein at least one contact-agent pairing included in the second portion of the second plurality of contact-agent pairings is within the third time interval.

A10. The method of any one of embodiments A1-A8, comprising: obtaining updated pairing data indicating a second plurality of contact-agent pairings performed using a second pairing strategy, wherein a first portion of the second plurality of contact-agent pairings was performed inside the second time interval and a second portion of the second plurality of contact-agent pairings was performed outside the second time interval; determining a number of contact-agent pairings included in the second portion of the second plurality of contact-agent pairings; based on the determined number of contact-agent pairings included in the second portion of the second plurality of contact-agent pairings, modifying a first buffer value, thereby generating a second buffer value; and determining a third time interval based on the expected wait time, the second weight value, and the second buffer value, wherein the second time interval is determined based on the expected wait time, the second weight value, and the first buffer value, and at least one contact-agent pairing included in the second portion of the second plurality of contact-agent pairings is within the third time interval.

A11. The method of embodiment A10, comprising: determining a second ratio of the determined number of contact-agent pairings included in the second portion of the second plurality of contact-agent pairings and a total number of the second plurality of contact-agent pairings; comparing the second ratio to a first threshold value and/or a second threshold value, thereby determining whether the second ratio is greater than the first threshold value or is less than or equal to the second threshold value, wherein the first buffer value is modified in case the second ratio is greater than the first threshold value or is less than or equal to the second threshold value, and the second threshold value is less than the first threshold value.

A12. The method of embodiment A11, wherein the second ratio is greater than the first threshold value, and modifying the first buffer value comprises increasing the first buffer value.

A13. The method of embodiment A11 or A12, wherein the third time interval is calculated based on (the second weight value×the expected wait time)+the first buffer value+a modification buffer value, and the modification buffer value is determined based on the second ratio.

A14. The method of embodiment A13, wherein

the modification buffer value is equal to the second ratio×100.

A15. The method of embodiment A11, wherein the second ratio is less than or equal to the second threshold value, and modifying the first buffer value comprises decreasing the first buffer value.

A16. The method of embodiment A11 or A15, wherein the third time interval is calculated based on (the second weight value×the expected wait time)+the first buffer value−a modification buffer value, and the modification buffer value is determined based on the second ratio.

A17. The method of embodiment A16, wherein the modification buffer value is equal to the first buffer value×a1, where a1 is a ratio of a number of contact-agent pairings included in the first portion of the second plurality of contact-agent pairings and the total number of the second plurality of contact-agent pairings.

A18. The method of any one of embodiments A10-A17, comprising: obtaining updated pairing data indicating a third plurality of contact-agent pairings performed using the second pairing strategy, wherein a first portion of the third plurality of contact-agent pairings was performed inside the third time interval and a second portion of the third plurality of contact-agent pairings was performed outside the third time interval; determining a number of contact-agent pairings included in the second portion of the third plurality of contact-agent pairings; based on the determined number of contact-agent pairings included in the second portion of the third plurality of contact-agent pairings, modifying the second buffer value, thereby generating a third buffer value; and determining a fourth time interval based on the expected wait time and the third buffer value, wherein at least one contact-agent pairing included in the second portion of the third plurality of contact-agent pairings is within the fourth time interval.

A19. The method of any one of embodiments A10-A18, comprising: performing contact-agent pairings using the first pairing strategy within the third time interval, and performing contact-agent pairings using the second pairing strategy outside the third time interval.

B1. A method (500) comprising: obtaining (s502) time data indicating a first time interval, wherein the first time interval is determined based on an expected wait time of contacts for pairing, a first weight value, and a first buffer value; obtaining (s504) pairing data indicating a first plurality of contact-agent pairings performed using a first pairing strategy, wherein a first portion of the first plurality of contact-agent pairings was performed inside the first time interval and a second portion of the first plurality of contact-agent pairings was performed outside the first time interval; determining (s506) a number of contact-agent pairings included in the second portion; based on the determined number of contact-agent pairings included in the second portion, modifying (s508) the first buffer value, thereby generating a second buffer value; and determining (s510) a second time interval based on the expected wait time, the first weight value, and the second buffer value, wherein at least one contact-agent pairing included in the second portion of the first plurality of contact-agent pairings is within the second time interval.

B2. The method of embodiment B1, comprising: determining a first ratio of the determined number of contact-agent pairings included in the second portion of the first plurality of contact-agent pairings and a total number of the first plurality of contact-agent pairings; comparing the first ratio to a first threshold value and/or a second threshold value, thereby determining whether the first ratio is greater than the first threshold value or is less than or equal to the second threshold value, wherein the first buffer value is modified in case the first ratio is greater than the first threshold value or is less than or equal to the second threshold value, and the second threshold value is less than the first threshold value.

B3. The method of embodiment B2, wherein the first ratio is greater than the first threshold value, and modifying the first buffer value comprises increasing the first buffer value.

B4. The method of embodiment B2 or B3, wherein the second time interval is calculated based on (the first weight value×the expected wait time)+the first buffer value+a modification buffer value, and the modification buffer value is determined based on the first ratio.

B5. The method of embodiment B4, wherein the modification buffer value is equal to the first ratio×100.

B6. The method of embodiment B2, wherein the first ratio is less than or equal to the second threshold value, and modifying the first buffer value comprises decreasing the first buffer value.

B7. The method of embodiment B2 or B6, wherein the second time interval is calculated based on (the first weight value×the expected wait time)+the first buffer value−a modification buffer value, and the modification buffer value is determined based on the first ratio.

B8. The method of embodiment B7, wherein the modification buffer value is equal to the first buffer value×a1, where a1 is a ratio of a number of contact-agent pairings included in the first portion of the first plurality of contact-agent pairings and the total number of the first plurality of contact-agent pairings.

B9. The method of any one of embodiments B1-B8, comprising: obtaining updated pairing data indicating a second plurality of contact-agent pairings performed using the first pairing strategy, wherein a first portion of the second plurality of contact-agent pairings was performed inside the second time interval and a second portion of the second plurality of contact-agent pairings was performed outside the second time interval; determining a number of contact-agent pairings included in the second portion of the second plurality of contact-agent pairings; based on the determined number of contact-agent pairings included in the second portion of the second plurality of contact-agent pairings, modifying the second buffer value, thereby generating a third buffer value; and determining a third time interval based on the expected wait time, the first weight value, and the third buffer value, wherein at least one contact-agent pairing included in the second portion of the second plurality of contact-agent pairings is within the third time interval.

B10. The method of any one of embodiments B1-B9, comprising: performing contact-agent pairings using the first pairing strategy outside the second time interval, and performing contact-agent pairings using a second pairing strategy within the second time interval.

B11. The method of any one of embodiments B1-B8 or B10, the method comprising: obtaining updated pairing data indicating a second plurality of contact-agent pairings performed using a second pairing strategy, wherein a first portion of the second plurality of contact-agent pairings was performed inside the second time interval and a second portion of the second plurality of contact-agent pairings was performed outside the second time interval; determining a number of contact-agent pairings included in the second portion of the second plurality of contact-agent pairings; based on the determined number of contact-agent pairings included in the second portion of the second plurality of contact-agent pairings, modifying the first weight value, thereby generating a second weight value; and determining a third time interval based on the expected wait time, the second weight value, and the second buffer value, wherein at least one contact-agent pairing included in the second portion of the second plurality of contact-agent pairings is within the third time interval.

B12. The method of embodiment B11, comprising: determining a second ratio of the determined number of contact-agent pairings included in the second portion of the second plurality of contact-agent pairings and a total number of the second plurality of contact-agent pairings; comparing the second ratio to a first threshold value and/or a second threshold value, thereby determining whether the second ratio is greater than the first threshold value or is less than or equal to the second threshold value, wherein the first weight value is modified in case the second ratio is greater than the first threshold value or is less than or equal to the second threshold value, and the second threshold value is less than the first threshold value.

B13. The method of embodiment B12, wherein the second ratio is greater than the first threshold value, and modifying the first weight value comprises increasing the first weight value.

B14. The method of embodiment B12 or B13, wherein the third time interval is calculated based on (the first weight value+a modification weight value)*the expected wait time+the second buffer value, and the modification weight value is determined based on the second ratio.

B15. The method of embodiment B14, wherein the modification weight value is equal to the second ratio.

B16. The method of embodiment B12, wherein the second ratio is less than or equal to the second threshold value, and modifying the first weight value comprises decreasing the first weight value.

B17. The method of embodiment B12 or B16, wherein the third time interval is calculated based on (the first weight value−a modification weight value)*the expected wait time+the second buffer value, and the modification weight value is determined based on the second ratio.

B18. The method of embodiment B17, wherein the modification weight value is equal to the first weight value×a1, where a1 is a ratio of a number of contact-agent pairings included in the first portion of the second plurality of contact-agent pairings and the total number of the second plurality of contact-agent pairings.

B19. The method of any one of embodiments B11-B18, comprising: obtaining updated pairing data indicating a third plurality of contact-agent pairings performed using the second pairing strategy, wherein a first portion of the third plurality of contact-agent pairings was performed inside the third time interval and a second portion of the second plurality of contact-agent pairings was performed outside the third time interval; determining a number of contact-agent pairings included in the second portion of the third plurality of contact-agent pairings; based on the determined number of contact-agent pairings included in the second portion of the third plurality of contact-agent pairings, modifying the second weight value, thereby generating a third weight value; and determining a fourth time interval based on the expected wait time, the second buffer value, and the third weight value, wherein at least one contact-agent pairing included in the second portion of the third plurality of contact-agent pairings is within the fourth time interval.

C1. A computer program (643) comprising instructions (644) which when executed by processing circuitry (602) of a node causes the node to perform the method of any one of the above embodiments.

C2. A carrier containing the computer program of embodiment C1, wherein the carrier is one of an electronic signal, an optical signal, a radio signal, and a computer readable storage medium (642).

D1. A node (600), the node comprising processing circuitry and being configured to perform the method of any one of embodiments A1-A19 and B1-B19.

E1. A node being configured to: obtain (s402) time data indicating a first time interval, wherein the first time interval is determined based on an expected wait time of contacts for pairing and a first weight value; obtain (s404) pairing data indicating a first plurality of contact-agent pairings performed using a first pairing strategy, wherein a first portion of the first plurality of contact-agent pairings was performed inside the first time interval and a second portion of the first plurality of contact-agent pairings was performed outside the first time interval; determine (s406) a number of contact-agent pairings included in the second portion; based on the determined number, modify (s408) the first weight value, thereby generating a second weight value; and determine (s410) a second time interval based on the expected wait time and the second weight value, wherein at least one contact-agent pairing included in the second portion is within the second time interval.

E2. The method of embodiment E1, wherein the node is further configured to perform the method of any one of embodiments A2-A19.

F1. A node being configured to: obtain (s502) time data indicating a first time interval, wherein the first time interval is determined based on an expected wait time of contacts for pairing, a first weight value, and a first buffer value; obtain (s504) pairing data indicating a first plurality of contact-agent pairings performed using a first pairing strategy, wherein a first portion of the first plurality of contact-agent pairings was performed inside the first time interval and a second portion of the first plurality of contact-agent pairings was performed outside the first time interval; determine (s506) a number of contact-agent pairings included in the second portion; based on the determined number of contact-agent pairings included in the second portion, modify (s508) the first buffer value, thereby generating a second buffer value; and determine (s510) a second time interval based on the expected wait time, the first weight value, and the second buffer value, wherein at least one contact-agent pairing included in the second portion of the first plurality of contact-agent pairings is within the second time interval.

F2. The method of embodiment F1, wherein the node is further configured to perform the method of any one of embodiments B2-B19.

G1. An apparatus (600) comprising: a processing circuitry (602); and a memory (641), said memory containing instructions executable by said processing circuitry, whereby the apparatus is operative to perform the method of any one of embodiments A1-B19.

### CONCLUSION

While various embodiments are described herein, it should be understood that they have been presented by way of example only, and not limitation. Thus, the breadth and scope of this disclosure should not be limited by any of the above described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method, the method comprising:
obtaining time data indicating a first time interval, wherein the first time interval is determined based on an expected wait time of contacts for pairing and a first weight value;
obtaining pairing data indicating a first plurality of contact-agent pairings performed using a first pairing strategy, wherein a first portion of the first plurality of contact-agent pairings was performed inside the first time interval and a second portion of the first plurality of contact-agent pairings was performed outside the first time interval;
determining a number of contact-agent pairings included in the second portion;
based on the determined number, modifying the first weight value, thereby generating a second weight value;
determining a second time interval based on the expected wait time and the second weight value, wherein at least one contact-agent pairing included in the second portion is within the second time interval;
obtaining updated pairing data indicating a second plurality of contact-agent pairings performed using a second pairing strategy, wherein a first portion of the second plurality of contact-agent pairings was performed inside the second time interval and a second portion of the second plurality of contact-agent pairings was performed outside the second time interval;
determining a number of contact-agent pairings included in the second portion of the second plurality of contact-agent pairings;
based on the determined number of contact-agent pairings included in the second portion of the second plurality of contact-agent pairings, modifying a first buffer value, thereby generating a second buffer value;
determining a third time interval based on the expected wait time, the second weight value, and the second buffer value, wherein
the second time interval is determined based on the expected wait time, the second weight value, and the first buffer value, and
at least one contact-agent pairing included in the second portion of the second plurality of contact-agent pairings is within the third time interval;
performing contact-agent pairings using the first pairing strategy within the third time interval, and
performing contact-agent pairings using the second pairing strategy outside the third time interval.

2. The method of claim 1, wherein the method further comprises:
determining a first ratio of the determined number of contact-agent pairings included in the second portion and a total number of the first plurality of contact-agent pairings; and
comparing the first ratio to a first threshold value and/or a second threshold value, thereby determining whether the first ratio is greater than the first threshold value or is less than or equal to the second threshold value, wherein
the first weight value is modified in case the first ratio is greater than the first threshold value or is less than or equal to the second threshold value, and
the second threshold value is less than the first threshold value.

3. The method of claim 2, wherein
the first ratio is greater than the first threshold value, and
modifying the first weight value comprises increasing the first weight value.

4. The method of claim 2, wherein
the second time interval is calculated based on (the first weight value+a modification weight value)*the expected wait time, and
the modification weight value is determined based on the first ratio.

5. The method of claim 4, wherein the modification weight value is equal to the first ratio.

6. The method of claim 2, wherein
the first ratio is less than or equal to the second threshold value, and
modifying the first weight value comprises decreasing the first weight value.

7. The method of claim 2, wherein
the second time interval is calculated based on (the first weight value−a modification weight value)*the expected wait time, and
the modification weight value is determined based on the first ratio.

8. The method of claim 7, wherein the modification weight value is equal to
the first weight value×a1, where a1 is a ratio of a number of contact-agent pairings included in the first portion and the total number of the first plurality of contact-agent pairings.

9. The method of claim 1, wherein
the first pairing strategy is a behavioral pairing (BP) strategy, and
the second pairing is different than the first pairing strategy.

10. A non-transitory computer readable storage medium storing a instructions which when executed by processing circuitry of a node causes the node to perform the method of claim 1.

11. A node, the node comprising:
memory; and
processing circuitry, wherein the node is configured to perform a method comprising:
obtaining time data indicating a first time interval, wherein the first time interval is determined based on an expected wait time of contacts for pairing and a first weight value;
obtaining pairing data indicating a first plurality of contact-agent pairings performed using a first pairing strategy, wherein a first portion of the first plurality of contact-agent pairings was performed inside the first time interval and a second portion of the first plurality of contact-agent pairings was performed outside the first time interval;
determining a number of contact-agent pairings included in the second portion;
based on the determined number, modifying the first weight value, thereby generating a second weight value;
determining a second time interval based on the expected wait time and the second weight value, wherein at least one contact-agent pairing included in the second portion is within the second time interval;
obtaining updated pairing data indicating a second plurality of contact-agent pairings performed using a second pairing strategy, wherein a first portion of the second plurality of contact-agent pairings was performed inside the second time interval and a second portion of the second plurality of contact-agent pairings was performed outside the second time interval;
determining a number of contact-agent pairings included in the second portion of the second plurality of contact-agent pairings;
based on the determined number of contact-agent pairings included in the second portion of the second plurality of contact-agent pairings, modifying a first buffer value, thereby generating a second buffer value;
determining a third time interval based on the expected wait time, the second weight value, and the second buffer value, wherein
the second time interval is determined based on the expected wait time, the second weight value, and the first buffer value, and
at least one contact-agent pairing included in the second portion of the second plurality of contact-agent pairings is within the third time interval;
performing contact-agent pairings using the first pairing strategy within the third time interval, and
performing contact-agent pairings using the second pairing strategy outside the third time interval.

12. The node of claim 11, wherein the method further comprises:
determining a first ratio of the determined number of contact-agent pairings included in the second portion and a total number of the first plurality of contact-agent pairings; and
comparing the first ratio to a first threshold value and/or a second threshold value, thereby determining whether the first ratio is greater than the first threshold value or is less than or equal to the second threshold value, wherein
the first weight value is modified in case the first ratio is greater than the first threshold value or is less than or equal to the second threshold value, and
the second threshold value is less than the first threshold value.

13. The node of claim 12, wherein
the first ratio is greater than the first threshold value, and
modifying the first weight value comprises increasing the first weight value.

14. The node of claim 12, wherein
the second time interval is calculated based on (the first weight value+a modification weight value)*the expected wait time, and
the modification weight value is determined based on the first ratio.

15. The node of claim 14, wherein the modification weight value is equal to the first ratio.

16. The node of claim 12, wherein
the first ratio is less than or equal to the second threshold value, and
modifying the first weight value comprises decreasing the first weight value.

17. The node of claim 12, wherein
the second time interval is calculated based on (the first weight value−a modification weight value)*the expected wait time, and
the modification weight value is determined based on the first ratio.

18. The node of claim 17, wherein the modification weight value is equal to
the first weight value×a1, where a1 is a ratio of a number of contact-agent pairings included in the first portion and the total number of the first plurality of contact-agent pairings.

19. The node of claim 11, wherein
the first pairing strategy is a behavioral pairing (BP) strategy, and
the second pairing is different than the first pairing strategy.
